(19) United States
(12) Patent Application Publication
(10) Pub. No.: US 2007/0075542 A1
(43) Pub. Date: Apr. 5, 2007

(54) PIPE FITTING

(76) Inventors: Alan Richard Glaze, Bromsgrove, Worcestershire (GB); Steven Paul Webb, Tipton, West Midlands (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/561,838

(22) Filed: Nov. 20, 2006

Related U.S. Application Data
(63) Continuation of application No. PCT/GB05/01889, filed on May 17, 2005.

(30) Foreign Application Priority Data
May 19, 2004 (GB) 0411099.5

(51) Int. Cl. F16L 21/06

(52) U.S. Cl. 285/322

(57) ABSTRACT

A pipe fitting comprising a housing (10:37:41) defining at ore rolled over end thereof an opening (36) through which it is intended a predetermined diameter pipe (28) is inserted, in use, with a clearance space between the pipe and the housing, The fitting has a grip-ring (19) for gripping the pipe (28) and a pipe support means (20:38) downstream of the grip-ring and ahead of sealing means (21). Downstream of the sealing means, are means (22:40) for limiting movement of the sealing means. The rolled over end of the housing effects engagement of the grip-ring with the housing and thus ensures electrical continuity between an inserted pipe and the housing. Also disclosed is a release tool (42) for use with the fitting.

This invention relates to a pipe fitting for use in coupling metallic pipes, particularly for hot and cold water applications.

Very many different types of pipe and tube fittings and couplers are known. Whilst some plastics material fittings can be used with copper pipes and some fittings of copper can be used with plastics pipe, it is usual for the material of the fitting to match the pipe with which it is to be used. In very many cases, however, the fitting incorporates several components and is relatively expensive to produce. With some such fittings, which are demountable, it is necessary to provide a component solely for the purpose of engagement by a release tool to release teeth of a grip-ring of the fitting from the pipe, in use.

An object of the invention is to provide a pipe fitting which is less expensive to produce and has less components than known pipe fittings.

According to a first aspect of the invention a pipe fitting comprises a housing defining at one end an opening for insertion of an end of a predetermined diameter pipe, in use, into the fitting with a clearance space at said open end between the pipe and the housing, the housing having therein a grip-ring, pipe support means downstream of the grip-ring in the direction of pipe insertion, sealing means downstream of the pipe support means, and means limiting movement of the sealing means in said pipe insertion direction, the diameter of said opening being greater than a diameter defined by the pipe support means.

Also according to said first aspect, there is provided a pipe fitting fitted to one end of a predetermined diameter pipe, the pipe passing through an open end of a housing of the fitting with a clearance space between the pipe and the housing and being gripped exteriorally by a grip-ring, the pipe passing through pipe support means downstream of the grip-ring in the direction of pipe insertion and sealing means downstream of the pipe support means, there being means limiting movement of the sealing means in said pipe insertion direction, the diameter of the open end of the fitting being greater than a diameter defined by the pipe support means.

Preferably the pipe fitting housing is of metallic material, such as copper tube, and said opening is defined by a generally diametrically deformed end part thereof. More preferably the housing is stepped along its length, to form a number of internal sections of successively decreasing diameters respectively. The grip-ring is received in the largest diameter section. Preferably the sealing means is received in the next largest diameter section. The pipe support means extend from the largest diameter section into the next largest diameter section.

Desirably the pipe support means is a spacer. More desirably it has a cylindrical body part, from an annular face at one end of which extends an outwardly directed annular projection. A radius or chamfer is provided at the internal junction between the annular face and the annular projection to act, in use, as a lead-in surface to encourage pipe insertion. The spacer is conveniently a brass pressing, but in an alternative form it could be moulded from plastics material or machined from bar.

In an alternative embodiment, the pipe support means is formed by an internal ring integral with the housing. The ring is formed by machining the housing internally and preferably it is formed with a lead-in surface for facilitating pipe insertion.

Advantageously the means limiting movement of the sealing means is a washer in the form of a plastics material, e.g. nylon or acetal, back-up ring. In an alternative embodiment the means limiting movement of the sealing means is a flat axially directed annular shoulder surface. Desirably it is formed by an integral machined internal part of the housing.

According to a second aspect of the invention, a pipe, fitting comprises a metallic housing defining at one end an opening for insertion of a metal pipe into the fitting, the housing having therein a metallic grip-ring with a multiplicity of teeth for gripping and retaining said inserted pipe, in use, the housing having its front edge deformed to define said opening at said one end and to retain the grip-ring within the housing and in contact with said housing thereby ensuring electrical continuity, in use, between an inserted pipe and the housing via said grip-ring.

Also according to said second aspect, there is provided a method of forming a pipe fitting comprising providing a metallic housing having a front edge at an open end of the housing, inserting into the housing a metallic grip-ring with a multiplicity of teeth for gripping and retaining a metal pipe inserted into the fitting, in use, and deforming said front edge to define an opening at said open end of the housing for insertion of said metal pipe into the housing and to retain the grip-ring within the housing thereby ensuring electrical continuity, in use, between an inserted pipe and the housing via said grip ring.

Preferably the deformation of said front edge of the housing is in the form of a rolled-over part defining said opening.

According to a third aspect of the invention there is provided a release tool for a pipe fitting in which a pipe is retained, in use, by the teeth of a grip-ring, the tool being engagable around the pipe, in use, as a complete or substantially complete ring defining a body having at one side thereof a circular or substantially circular leading edge adapted to enter the pipe fitting around the pipe, in use, as the release tool is advanced to engage the fitting, and to engage all of the teeth of the grip-ring, the leading edge being adapted so as to force the teeth but of the engagement with the pipe, thereby permitting removal of the pipe from the pipe fitting.

Conveniently the tool is in one-piece, and is preferably a plastics moulding, for example of acetal copolymer. In one embodiment the tool is a split ring openable and closable about an integral hinge point. The leading edge is formed as a smaller diameter projection from the main body of the ring. Preferably the outer surface of the leading part of the projection is chamfered to provide said angle to said leading edge.

According to a fourth aspect of the invention there is provided a release tool of said third aspect together with a pipe fitting of said first or second aspects.

The invention will now be described, by way of example, with reference to the accompanying drawings, in which:

FIG. 1 is a longitudinal cross-sectional view of a housing of a pipe fitting of the invention prior to internal components of the fitting being received therein and the housing ends deformed to retain them in position,

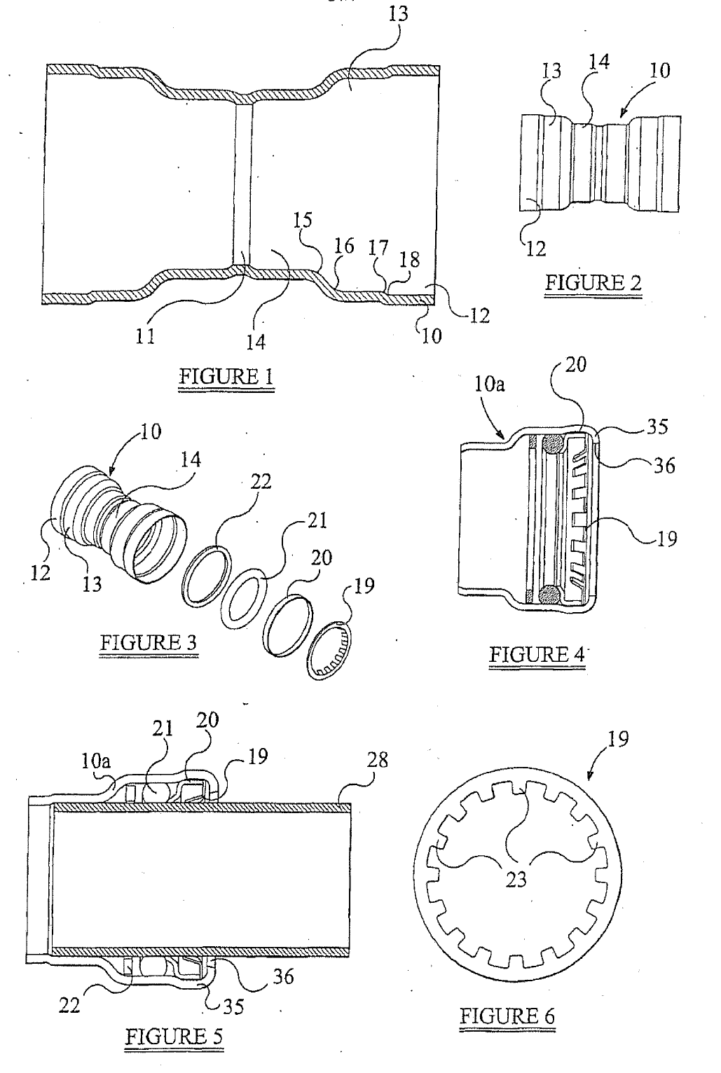

FIG. 2 is a smaller scale side view of the housing of FIG. 1,

FIG. 3 is an exploded perspective view of components of a pipe fitting of the invention,

FIG. 4 is a longitudinal cross-sectional view of a pipe fitting of the invention,

FIG. 5 is a view of a fitting like that of FIG. 4, with a pipe retained therein,

FIGS. 6 to 8 are respectively a plan view, a diameteral cross-sectional view and a side view of a grip ring of the fitting shown in FIGS. 3 to 5, to a larger scale,

FIGS. 9 to 11 are respectively a plan view, a side view and a diametrical cross-sectional view of a pipe support washer of the fitting shown in FIGS. 3 to 5, to a larger scale,

FIGS. 12 to 14 are respectively views corresponding to FIGS. 9 to 11, of an alternative form of pipe support washer,

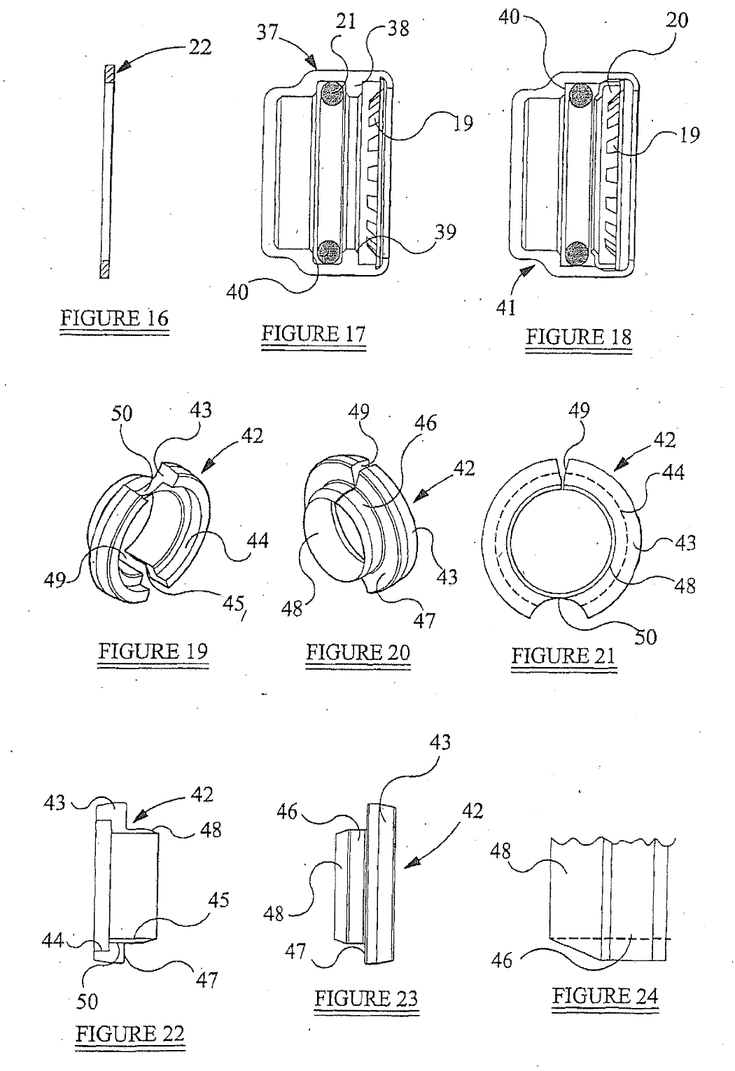

FIGS. 15 and 16 are respectively a plan view and a diameteral cross-sectional view of a back up washer of the fitting of FIGS. 3 to 5 to a larger scale,

FIGS. 17 and 18 are further embodiments respectively of fittings of the invention,

FIGS. 19 and 20 are respective rear and front perspective views of a release tool of the invention for use with the pipe coupling,

FIGS. 21 to 23 are respectively a plan view, a vertical diametral cross-sectional view and a side view of the tool of FIGS. 19 and 20, and

FIG. 24 is on enlarged scale scrap section showing the angle of a leading face of the release tool.

The embodiment of the invention shown in FIGS. 1 to 16 of the drawings is in the form of a pipe fitting which is improved over similar known pipe fittings in utilising a minimum number of components in a housing which is significantly smaller than those of said known fittings. In particular the outer housing of the fitting is made of copper tube, with the fitting itself being intended for use with copper piping. Alternatively the outer housing could be of brass. In particular this allows components used with known pipe fittings to prevent ‘folding’ of the grip-ring, to be dispensed with, and additionally, as will be described hereinafter, the relationship between the housing and the internal fitting components enables the fitting to be releasable without the need for an intermediate component between the grip-ring and a release tool. As a consequence, a fitting of the present invention is less expensive to produce than similar known pipe fittings.

FIGS. 1 and 2 show one form of housing 10 of a pipe fitting of the invention, with FIG. 3 showing the housing as well as the internal fittings which are received at each of the two ends thereof. The housing 10 is formed with various internal and correspondingly external stepped sections as shown best in FIG. 1 by any suitable techniques, such as punch and die forming or roll forming. As can be seen from FIG. 1, the housing 10 is symmetrical about a diameteral plane through its longitudinal centre, with each half extending from this minimum diameter centre section 11 being formed with three stepped sections 12, 13, 14 respectively of different internal, and external, diameters.

In FIG. 1 the largest diameter section 12 is at the open end of the housing, the smallest diameter section 14 is adjacent the centre section 11, and the section 13, having a diameter between those of the sections 12 and 14, is disposed between those sections, so that, as can be seen from FIG. 1, the internal, and external, diameters of the housing increase stepwise from the centre section 11 to the open end of the housing, this arrangement being repeated at both sides of the centre section 11, given that, as stated above, the housing is symmetrical about that section. As far as the respective diameters are concerned, it can be seen from FIG. 1 that the diameter of the centre section 11 is only slightly smaller than that of the section 14, whereas the diameter of the middle section 13 is relatively much larger than that of the section 14. Finally, it can be seen from FIG. 1 that the diameter of the largest section 12 is only slightly greater than the diameter of the section 13. All three sections are of similar axial extent, although the section 12 is slightly shorter than either of the sections 13 and 14. It can also be seen from FIG. 1 that the internal Junction between the section 14 and the section 13 is formed by a convex radius 15 leading to a concave radius 16, whilst at the internal junction between the section 13 and the section 12, there are similarly convex and concave radii 17, 18 respectively, although the radii 17, 18, are significantly smaller than the corresponding radii 15, 16. Since, as will be described, insertion of a pipe to be used with the fitting is into the open end at the section 12, in a direction towards the centre section 11, reference hereinafter to ‘downstream’ in relation to a position of fittings in the housing will be in relation to this insertion direction.

It will be understood that the housing 10 shown in FIGS. 1 to 3 is intended for the insertion of respective pipes into its two opposite open ends respectively, and a fitting of the invention would normally be of this form. However it is within the scope of the invention for the housing to comprise only one half of the housing shown in FIG. 10, i.e. as shown in FIGS. 4 and 5. For example here, the half of the housing shown could be an integral part of some other pipe or tube, or other fitting, and it is thus to be understood that the invention is not limited to the form of housing shown in FIGS. 1 to 3. However where this form of housing is used, the four internal fitting components shown in FIG. 3 would be received in both open ends of the fitting as shown in FIG. 4 for the one half of the housing illustrated therein.

Accordingly FIG. 3 shows the internal components of the fitting for reception into one of the open ends thereof, these components comprising a grip-ring 19, pipe support means in the form of a spacer 20, sealing means in the form of a rubber O-ring 21 abutting a rear face of the spacer, and a backup washer 22, all of these four components being in the form of circular rings. The washer 22 can be metallic, or of plastics material, such as nylon or acetal. These components 19 to 22 are shown in FIGS. 4 and 5, fitted in a housing 10a which, as explained above, is shown as half of the housing 10, but with the open end of the housing deformed, to complete the fitting, as will be explained below. The O-ring 21 could be secured, i.e. glued, to the rear face of the spacer.

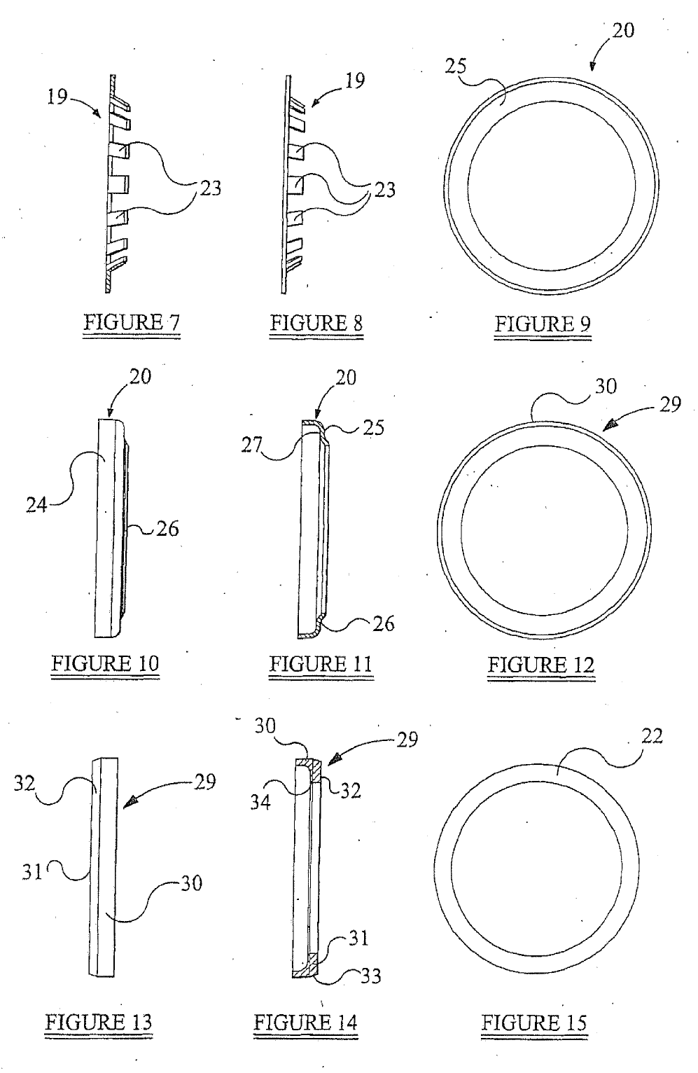

The grip-ring 19, shown in detail in FIGS. 6 to 8, is of generally conventional form, being of stainless steel, and having a multiplicity of regularly spaced internal teeth 23, the teeth extending outwardly from the main ring-like body of the component as shown in FIGS. 7 and 8. The angle of inclination of the teeth is, for example, between 45 and 50°. As shown in FIGS. 4 and 5, the grip-ring 19 is positioned in the housing 10a adjacent to the open end thereof, and positioned downstream of this grip-ring 19 is the spacer 20, shown in detail in FIGS. 9 to 11. In this embodiment the spacer 20 is a brass pressing having a cylindrical body part 24 with an annular face 25 at one of its open ends. From the inner circumference of this annular face 25 extends an outwardly directed angled annular projection 26, a typical value for the inclination of this projection 26 being between 45 and 55°. From FIG. 11 it will be noted that at the inside of the face 25 its junction with the projection 26 is formed as a radius 27, this, as will be described hereinafter, encouraging pipe insertion into the fitting. The O-ring 21 is of conventional form, typically being of circular cross-section in its uncompressed state, whilst the back up washer 22 is also of conventional washer form, as shown in FIGS. 15 and 16, merely being a rectangular cross-section ring with a relatively large internal diameter to receive therethrough the end of the pipe 28 used with the fitting. FIGS. 12 to 14 show an alternative form of the pipe support means of the fitting, namely of the spacer 20 shown in FIGS. 9 to 11. The spacer 29 shown in FIGS. 12 to 14 may, like the spacer 20 be formed of brass, and again has a cylindrical body part, here denoted by the numeral 30, However instead of the angled outwardly directed annular projection 26 of the spacer 20, the spacer 29 has integrally formed at the outside of the annular face of the spacer an annular portion 31 which itself provides an external annular face 32 which is flat. Its annular side surface 33 is chamfered downwardly away from the body part 30, as shown in FIG. 14, whilst the inner circumferential part of the annular face of the body part 30 is chamfered as shown at 34 where it joins the portion 31, this again providing a lead-in surface for the inserted pipe 28. Whilst, as described, the pipe support means can be washers formed by pressing, the washers could instead be moulded in plastics material or machined from bar.

After the four components have been inserted into an end of the housing 10, or the housing 10a, in the order shown, i.e. with the grip-ring ahead of the spacer, and the spacer ahead of the O-ring, which is, itself ahead of the backup washer, which is thus furthest downstream in the housing, the open end of the housing is deformed so as to encapsulate the fitted internal components as shown for the housing 10a in FIGS. 4 and 5. Conveniently this involves rolling the front edge of the open tube end shown in FIG. 1 so that this edge is deformed to lie at substantially 90° to the remainder of the housing, i.e to be disposed diametrically as opposed to axially of the housing. This roll-over part 35 of the housing not only serves to retain the grip-ring, and the other fitting components within the housing, such components up until then being free in the housing, but also defines an opening 36 of a pre-determined radius at the front of the fitting, the size of this opening being greater than the outer diameter of the pipe 28 with which the fitting is intended to be used. The rolling over effects contact between the grip-ring and the body. Accordingly, as shown in FIG. 5, for the inserted pipe, there is clearance around the outside of the pipe at the opening 36. This arrangement is in contrast to known pipe fittings, where the housing itself, an end cap, or an additional component is provided to support the pipe inserted into the fitting. In contrast, with the fitting of the present invention, the pipe is unsupported at the entrance to the fitting, and is instead supported downstream of the grip-ring, by the pipe support means in the form of the spacer 20 (or spacer 29) described.

To produce a joint between the pipe 28 and the fitting shown, for example in FIG. 4 and 5, the pipe 28 is aligned with the opening 36 at the mouth of the fitting and pushed-in until the pipe reaches the stepped junction or shoulder formed between the centre section 11 and the section 14, as shown in FIG. 5, the shoulder thus forming a stop to prevent further pipe insertion. The insertion of the pipe causes flexing of the teeth 23, such that when the pipe is fully inserted, the teeth 23, due to their inherent ‘springiness’ tightly engage and grip the exterior surface of the pipe, thereby preventing manual ‘pu1ling-out’ of the pipe from the fitting. It can be seen from FIG. 5 that the grip-ring is retained in place against the rolled-over part 35 of the housing, whilst the open end of the spacer 20 engages the circular main part of the grip-ring at its side from which the teeth project. The O-ring forms a seal with the pipe and the housing, and also engages the projection 26 as shown.

Accordingly in the condition shown in FIG. 5, a watertight joint is achieved by means of the O-ring being in a compressed state between the pipe and the housing. To prevent compression of the O-ring during tube insertion, the spacer 20 is at an outer diameter such as to prevent its movement into section of the housing where the sealing takes place. This same feature provides a point of resistance sufficient to allow displacement of the grip-ring teeth upon insertion of the pipe 28. The spacer 20 is made in a form and thickness sufficient to provide a degree of support to the tube 28 to limit the amount of available eccentric movement of the pipe. This is desirable in that excessive eccentric movement of the pipe can degrade the functionality of the O-ring seal. As stated previously, the spacer 20 has a radius 27, and the spacer 29 a chamfer 34, to encourage pipe insertion.

In addition to supporting the pipe, the spacer 20 or the spacer 29 each act to prevent migration of the O-ring from its specified section of the housing 10 into the adjacent spacer and grip-ring diameter section, thus losing compression and acquiring potential for seal failure. A particular inventive feature of the fitting is that, as shown in FIGS. 4 and 5, the grip-ring is in contact with the metal housing 10a, so that when the pipe 28, also of metal, is inserted into the fitting, as shown in FIG. 5, electrical continuity is ensured between the pipe and the housing. This is important as it is often a requirement with fittings used at present. With some known fittings, this electrical continuity is not reliably achieved, even if the pipe is supported at the entrance to the fitting, rather than downstream thereof as with the present invention. In, the present invention, the electrical continuity is preferably achieved by the deformation, e.g. rolling over, of the front edge of the housing, which brings the grip-ring and housing into contact.

Accordingly whilst one aspect of the present invention is the fact that the diameter of the opening into the fitting is greater than the diameter of the inserted pipe, and thus greater than the diameter defined by the pipe support means, namely the spacer 20 or 29, a further, independent aspect of the invention is that the fitting ensures electrical continuity between an inserted pipe and the housing by virtue of the engagement of at least part of the grip-ring with the housing when the pipe, grip-ring and housing are all of electrically conductive material.

Whilst in the embodiments described above, the pipe support means are separate spacer components, FIG. 17 shows an alternative form of housing 37, with a closed downstream end, in which the pipe support means is formed as an integral internal annular projection 38 disclosed diametrically in the housing between the O-ring 21 and the grip-ring 19, the projection 38, and indeed the remaining internal structure of the housing, being formed by machining. As can be seen from FIG. 17, the annular projection 38 is formed with a pipe lead-in part 39 in the form of an annular chamfer facing the grip-ring teeth. It will also be noted from FIG. 17 that no backup washer is provided downstream of the O-ring seal. Instead an annular shoulder 40 is provided at the end of the section of the internal housing part which receives the O-ring seal, this forming a stop for the seal, being disposed radially of the housing and facing axially.

FIG. 18 shows a further alternative form of housing, this being denoted by the numeral 41. The housing 41 is similar to the housing 37 but replaces the projection 38 by the spacer 20 which cooperates with the grip-ring and the O-ring seal in a similar way to that shown in FIG. 5. However with this housing the shoulder 40 of the housing 37 is again provided, so that the backup washer is again omitted.

It will be appreciated that with each of the housings of FIGS. 17 and 18, the downstream end thereof may be open rather than closed.

The fitting of the present invention is designed so that a pipe fitted thereto, as shown in FIG. 5, can be released therefrom by the use of a specially designed release tool 42 shown in FIGS. 19 to 24. This tool is preferably formed of plastics material, such as acetal copolymer, and whilst it can be used as a release tool in itself, it could be incorporated into some form of existing release tool to provide extra leverage for release. However its use will be described as a release tool in itself. Instead of being of plastics material, the release tool could be of metal, e.g. spring steel.

The tool comprises a main body part 43 which is of generally hollow cylindrical form having at its one end a circular opening 44 of a diameter greater than the external diameter of the pipe 28. This opening 44 is stepped down within the main body part 43, and from this step there extends outwardly from the other end of the main body part 43 an integral hollow circular projecting part 45. This part 45 has a cylindrical portion 46 immediately adjacent the front flat annular face 47 of the part 43, and an externally inwardly chamfered portion 48 of circular form at the outer end of the portion 46, thereby defining a leading edge part of the tool. Although the tool is formed in one piece, it can be seen best from FIG. 21, that it is provided with a split formed by a V-cut 49, the tool being provided at a position diametrically opposite with an integral hinge point 50 formed by a cutting away of a material of the parts 43, 46 and 48 in the form, for example, of a semi-circle. In alternative forms, the release tool could be formed of two or more separate parts which can be ‘assembled’ together to form a ring around the pipe, as with the tool 42.

In operation, the release tool 42 is opened about its hinge point 50, and is placed around the pipe 28 and then closed onto it so that the tool is in its FIGS. 20 and 21 position, i.e. fully closed up around the pipe, on which it is a close fit, by virtue of the bore through the projecting part 45 substantially matching the external diameter of the pipe 28.

The now circular assembly into which the release tool is formed is then advanced along the pipe until the leading part thereof, namely the chamfered portion 48 reaches the front of the fitting. This portion 48 is arranged and sized so that it can enter the annular clearance shown best in FIG. 5, defined between the external surface of the pipe 28 and the internal surface of the opening 36 at the mouth of the fitting. Accordingly as the chamfered portion 48 is received through this clearance, it engages the teeth 23 of the grip-ring 19 and pushes them in a direction away from the pipe so as to release the grip of the teeth thereon. In other words the angle of the grip-ring teeth is altered, consequently opening the bite diameter of the grip ring, thereby allowing disengagement of the pipe to occur by pulling it from the fitting for as long as the teeth are held out of engagement therewith. It will be appreciated that it is important for the angle of the chamfer of the external surface of the portion 48 to be such that it will correctly lift the teeth 23 of the grip ring out of engagement with the pipe. In the example illustrated, and as shown in FIG. 24, this chamfer angle is 20°. However for other grip rings, this chamfer angle could be different, and in fact could be 0°, i.e. the leading edge of the release tool could be axial. However in all cases it is important for a tool with the correctly disposed leading edge to be used so that the teeth are correctly engaged and the force applied thereto in the correct direction to effect release from the pipe. Once the pipe has been fully removed from the fitting, the release tool 42 can similarly be extracted therefrom, thereby allowing the teeth to return to their relaxed position shown in FIGS. 6 to 8 ready for the next use of the fitting to engage a pipe. It is also to be noted that it is necessary for all of the teeth of the grip ring to be released by the release tool in order to be able to effect release of the pipe.

1-39. (canceled)

40. A pipe fitting comprising a housing defining at one end an opening for insertion of an end of a predetermined diameter pipe, in use, into the fitting with a clearance space at said open end between the pipe and the housing, the housing having therein a grip ring, pipe support means downstream of the grip ring in the direction of pipe insertion, sealing means downstream of the pipe support means, and means limiting movement of the sealing means in said pipe insertion direction, the diameter of said opening being greater than a diameter defined by the pipe support means, wherein the pipe support means is formed by an internal ring integral with the housing.

41. A pipe fitting as claimed in claim 40, wherein the pipe fitting housing is of metallic material.

42. A pipe fitting as claimed in claim 41, wherein the metallic material is copper tube.

43. A pipe fitting as claimed in claim 40, wherein the housing is stepped along its length, to form a number of internal sections of successively decreasing diameters respectively.

44. A pipe fitting as claimed in claim 43, wherein the grip ring is received in the largest diameter section.

45. A pipe fitting as claimed in claim 44, wherein the sealing means is received in the next largest diameter section.

46. A pipe fitting as claimed in claim 45, wherein the pipe support means extend from the largest diameter section into the next largest diameter section.

47. A pipe fitting as claimed in claim 40, formed by machining the housing internally.

48. A pipe fitting as claimed in claim 40, wherein the ring is formed with a lead-in surface for facilitating pipe insertion.

49. A pipe fitting as claimed in claim 40, wherein the means limiting movement of the sealing means is a washer.

50. A pipe fitting as claimed in claim 49, wherein the washer is in the form of a plastics material back-up ring.

51. A pipe fitting as claimed in claim 40, wherein the means limiting movement of the sealing means is a flat axially directed annular shoulder surface.

52. A pipe fitting as claimed in claim 51, wherein the shoulder surface is formed by an integral machined internal part of the housing.

53. A pipe fitting as claimed in claim 40, wherein the sealing means is an O-ring of resilient material.

54. A pipe fitting as claimed in claim 40, wherein the housing has its front edge deformed to define said opening at said one end and to retain the grip ring within the housing and in contact with said housing thereby ensuring electrical continuity, in use, between the inserted pipe and the housing via said grip ring.

55. A pipe fitting as claimed in claim 54, in which said deformation of said front edge of the housing is in the form of a rolled-over part defining said opening.

56. A pipe fitting as claimed in claim 55, in which the deformation also retains in the housing the sealing means.

57. A pipe fitting fitted to one end of a predetermined diameter pipe, the pipe passing through an open end of a housing of the fitting with a clearance space between the pipe and the housing and being gripped exteriorly by a grip ring, the pipe passing through pipe support means downstream of the grip ring in the direction of pipe insertion and sealing means downstream of the pipe support means, there being means limiting movement of the sealing means in said pipe insertion direction, the diameter of the open end of the fitting being greater than a diameter defined by the pipe support means, wherein the pipe support means is formed by an internal ring integral with the housing.

58. A pipe fitting as claimed in claim 57, wherein the pipe fitting housing is of metallic material.

59. A pipe fitting as claimed in claim 58, wherein the metallic material is copper tube.

60. A pipe fitting as claimed in claim 57, wherein the housing is stepped along its length, to form a number of internal sections of successively decreasing diameters respectively.

61. A pipe fitting as claimed in claim 60, wherein the grip ring is received in the largest diameter section.

62. A pipe fitting as claimed in claim 61, wherein the sealing means is received in the next largest diameter section.

63. A pipe fitting as claimed in claim 62, wherein the pipe support means extend from the largest diameter section into the next largest diameter section.

64. A pipe fitting as claimed in claim 57, formed by machining the housing internally.

65. A pipe fitting as claimed in claim 57, wherein the ring is formed with a lead-in surface for facilitating pipe insertion.

66. A pipe fitting as claimed in claim 57, wherein the means limiting movement of the sealing means is a washer.

67. A pipe fitting as claimed in claim 66, wherein the washer is in the form of a plastics material back-up ring.

68. A pipe fitting as claimed in claim 57, wherein the means limiting movement of the sealing means is a flat axially directed annular shoulder surface.

69. A pipe fitting as claimed in claim 68, wherein the shoulder surface is formed by an integral machined internal part of the housing.

70. A pipe fitting as claimed in claim 57, wherein the sealing means is an O-ring of resilient material.

71. A pipe fitting as claimed in claim 57, wherein the housing has its front edge deformed to define said opening at said one end and to retain the grip ring within the housing and in contact with said housing thereby ensuring electrical continuity, in use, between the inserted pipe and the housing via said grip ring.

72. A pipe fitting as claimed in claim 71, in which said deformation of said front edge of the housing is in the form of a rolled-over part defining said opening.

73. A pipe fitting as claimed in claim 72, in which the deformation also retains in the housing the sealing means.
